(19) United States
(12) Patent Application Publication
(10) Pub. No.: US 2022/0214004 A1
(43) Pub. Date: Jul. 7, 2022

(54) SPLIT SEGMENTED BEND RESTRICTOR

(71) Applicant: PMI Industries, Inc., Cleveland, OH (US)

(72) Inventor: Terry Zahuranec, North Olmsted, OH (US)

(21) Appl. No.: 17/608,306

(22) PCT Filed: May 1, 2020
(86) PCT No.: PCT/US2020/030898

§ 371 Date: Nov. 2, 2021

Related U.S. Application Data
(60) Provisional application No. 62/842,105, filed on May 2, 2019.

(51) Int. Cl. F16L 57/02; F16L 11/18; H02G 3/04

(52) U.S. Cl. CPC F16L 57/02; H01B 7/14; H02G 3/0475; F16L 11/18

(57) ABSTRACT

An improved method and apparatus for providing bend limits and cable protection on medium to large diameter (approx. 30 mm-300 mm) seismic towed arrays, umbilicals as well as medium and high voltage power and/or communications subsea cables. These medium to high voltage cables are typically used on stationary and floating wind turbines and other offshore platforms such as used by the oil and gas industries. This system is an improvement over existing designs and techniques commonly used for this bend limiting purpose.

### BACKGROUND

This application claims the priority benefit of U.S. provisional application Ser. No. 62/842,105, filed May 02, 2019, the entire disclosure of which is incorporated herein by reference. This application relates to a bend restrictor used to encase or encompass a flexible line, cable, conduit, etc., and a method of making the bend restrictor.

Bend restrictor designs are known including commonly owned US 2016/0186893A1, the entire disclosure of which is incorporated herein by reference, and other commercially available designs that provide bend limits and protection of a flexible line, cable, or conduit to prevent damage, for example, to wires or fiber optics housed within the cable. Many of these designs use clamps and/or bolts to secure together first and second housing components, parts, or portions (typically housing halves). These known designs unfortunately often require tools, threaded fasteners, and an extended amount of time to align and/or assemble individual components or parts.

Other known designs use polymer clamping wedges, hinges, or clips driven into the sections to secure or lock the housing halves to each other.

A need exists therefore to simplify the structure and method of assembling bend restrictors.

### SUMMARY

A segmented cable protection device is provided that limits the minimum bend radius of a cable.

The cable protection device includes first and second housing portions that form a segment of the device. The first and second housing portions each include interlocking protrusions. Each protrusion has an internal passageway for receiving a locking pin. The device further includes a locking collar that retains the pin of the segment(s) in place.

In a first embodiment, the first and second housing portions are identical.

In a preferred arrangement, the first and second housing portions form one-half of the segment.

The housing may be formed at least in part of urethane.

In a preferred arrangement, the urethane is in the range of approximately Shore hardness 85A-80D.

In a preferred embodiment, a strengthening member is received in the urethane and, for example, the strengthening member includes at least one of reinforcement materials, rods, springs, matting, ropes, formed shapes or stiffening members.

A thermally conductive material may be incorporated in the urethane that enhances thermal conductivity and reduces heat buildup from the associated cable.

The housing portions are dimensioned to form a through opening that ranges from 30-300 mm in diameter.

In one version, a urethane molding is received over the assembled first and second housing portions.

The locking pins of adjacent segments may be located at different circumferential positions in different segments in order to offset dividing planes of the segments.

The housing portions may be formed of a material or combination of materials that have a buoyancy in water.

A primary benefit resides in the provision of a simple pin locking arrangement and method.

Another advantage is the reduced time required to assemble the housing sections onto the flexible cable.

Still another benefit is associated with the ease with which mechanical properties of the segment section may be altered, e.g., strength, rigidity, thermal conductivity, etc.

Other advantages are associated with the ease of installation onto the cable with a minimal use of tools, minimal trading needed for installation, ease of handling by providing housings in split sections, customizable starter segments and bending strain reliefs, as well as customize load requirements by using a variety materials for reinforcement and meeting desired loads (e.g. incorporating urethane, plastics, aluminum, steels, cast iron, etc.).

Still other benefits and advantages will become apparent upon reading and understanding the following detailed description.

### BRIEF DESCRIPTION OF THE DRAWINGS

FIG. 1 is a perspective view of an assembled bend restrictor that includes at least first and second segments.

FIG. 2 is a perspective view of the bend restrictor of FIG. 1 with selected transparent portions to illustrate internal features.

FIG. 3 is a perspective view of a partially assembled bend restrictor.

FIG. 4 is a perspective, cross-sectional view of the assembled bend restrictor of FIG. 1.

FIG. 5 is another perspective, cross-sectional view of the assembled bend restrictor of FIG. 1 at a circumferential location void of any pins.

FIG. 6 is an enlarged perspective, interior view of a housing portion.

FIG. 7 is an enlarged perspective, exterior view of the housing portion of FIG. 6.

FIGS. 8-10 are enlarged perspective, exterior views of the housing portion similar to FIG. 7 that incorporate different types of reinforcement structure.

FIG. 11-13 are perspective views of the assembled bend restrictor and individual, disassembled first and second housing portions thereof, formed of a metal design for higher loads.

FIG. 14 is a perspective view of one of the housing portions with a urethane over-mold.

### DETAILED DESCRIPTION

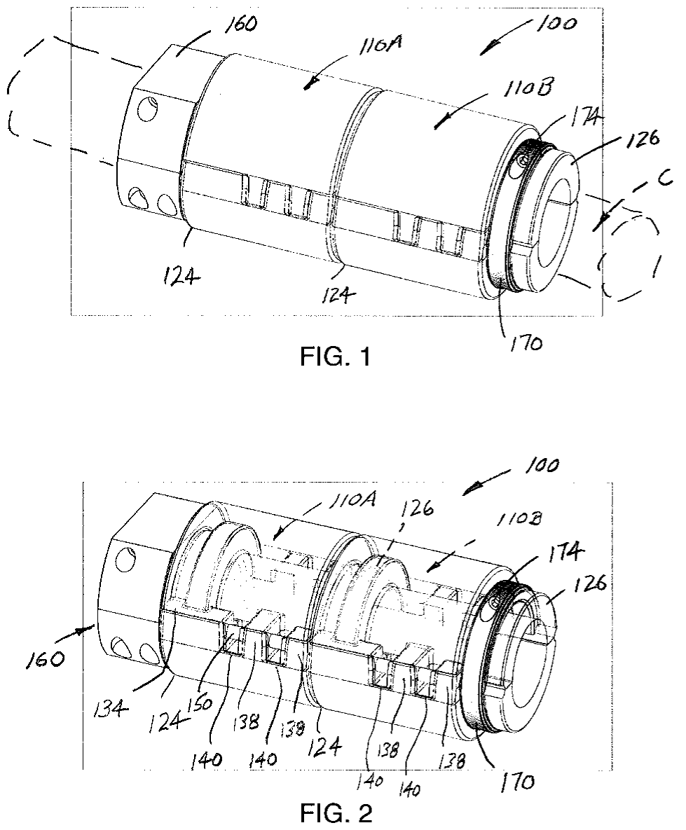

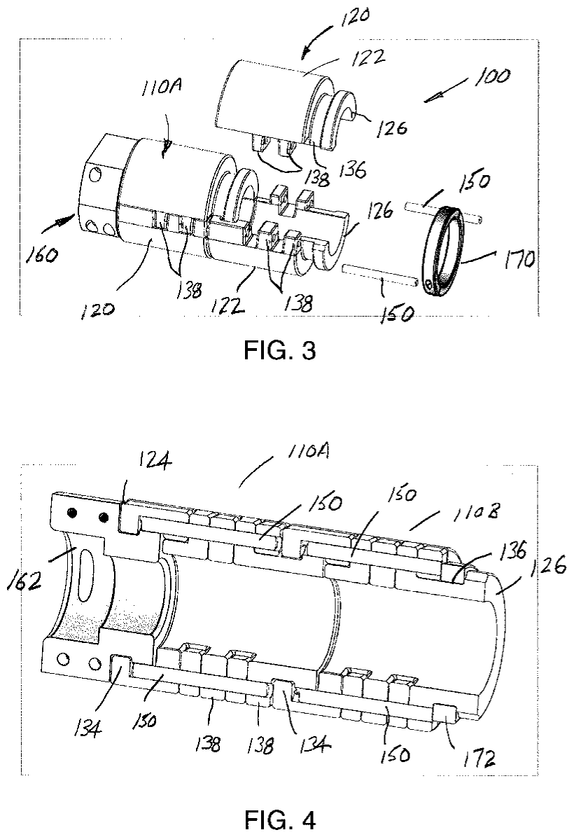

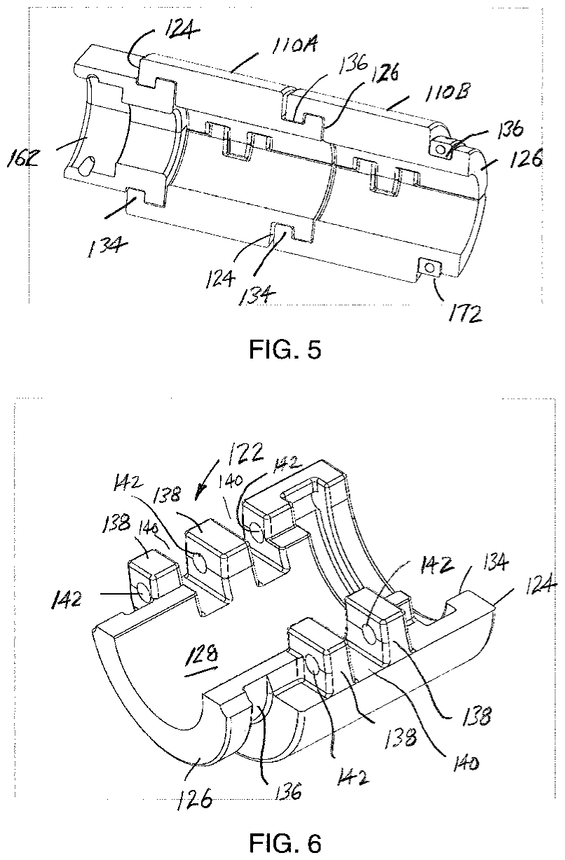

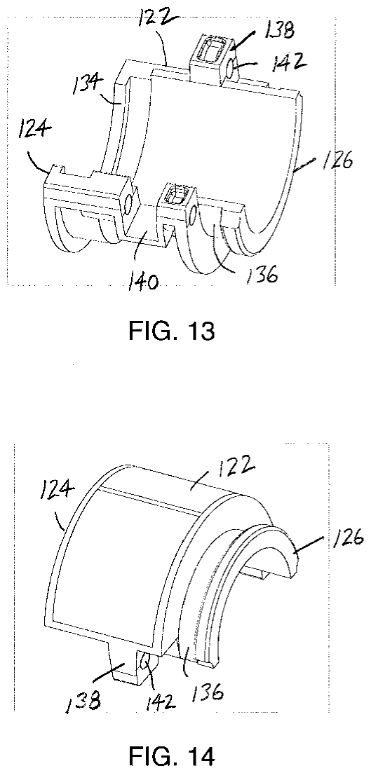

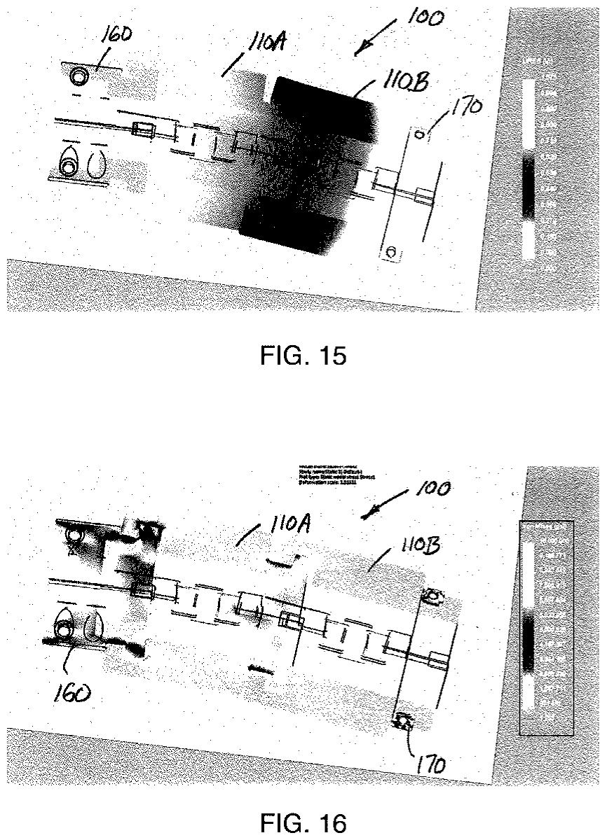

An improved method and apparatus are shown in FIGS. 1-14 and described herein for providing bend limits and protection for a flexible line, cable, conduit, on medium to large diameter seismic total raise, umbilicals, medium and high-voltage power and/or communication subsea cables, etc. these medium to high voltage cables are typically used on stationary floating wind turbines, or other offshore platforms such is used in the oil and gas industries.

A split housing bend restrictor is intended for use on an associated cable and the bend restrictor designed to limit the bend radius of the cable. The design incorporating identical housing halves that have protrusions or interengaging, tooth-like protrusions and alternating recesses or gaps that have an axial passage within these protrusions. The passages of interengaging housing halves align when the housing halves are assembled over the cable and mated to each other. Two locking pins slide into these passages thus locking the housing halves together, and forming a first segment of the bend limiting device. The next or second segment is then assembled onto the cable and over the end section of the first segment. The second segment includes a circumferential, radially extending flange at a first end thereof that extends inward into engagement with a circumferential, radially extending recess at a second end of the first segment. By radially capturing the flange in the first end of the second segment in the recess in the second end of the first segment, limited pivoting movement of the first segment relative to the second segment is possible. The extent of this pivoting movement is designed to provide incremental bending in the radial direction at discrete axially spaced locations where the segments overlap. Depending on the amount of permitted pivoting movement between the segments, and the number of segments disposed in the end-to-end, axial engagement of segments determines the overall bend limiting properties of the bend restrictor.

When the housing halves are received over a portion of the cable and the protrusions of one housing half received in the recesses of the other housing half, the housing halves are then secured by inserting the locking pin through the aligned passages that extend axially through the protrusions of the housing halves. Preferably, two locking pins slide into these passages and lock the housing halves together forming one segment of the bend limiting device. The second segment is then assembled onto the cable, over the end section of the previous segment, and then secures the locking pin in the housing limiting axial movement. This is then repeated until enough segment sections are assembled on the cable to reach the desired level of protection. A split locking collar is then secured to the last segment to retain the last set of locking pins in position. It should be noted that the first segment could be secured to a starter flange, mid-span mount, attachment coupling, wind hang-off, or another bending strain relief of a different construction.

The material of the segments can be constructed from urethane, plastic, stainless steels like 316 and 17-4PH, cast iron, duplex and super duplex steels or any other material that may provide the properties needed. Reinforcement members made up of rods, helical rods, shaped rods, woven fibers, mats, ropes or stamped metal forms can be added and over molded within the segments to alter the mechanical properties of the segment section.

For the exemplary embodiments, 86 mm ID (Dyna Hanger size) and 150 mm ID (inner array cable size) have been designed. A urethane version can be easily modifiable to different sizes.

Materials, for example urethane, plastics, aluminum, steels and cast iron can be customized or reinforced to meet desired load requirements.

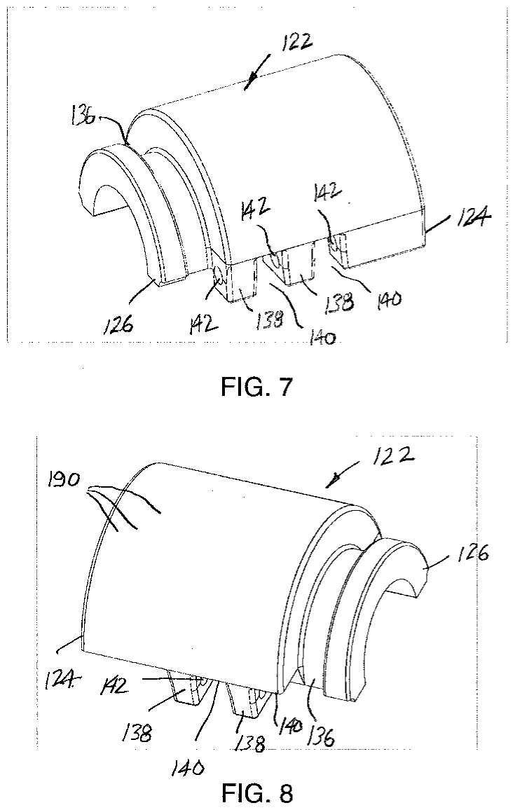

As individually shown in FIGS. 6 and 7, and also illustrated in FIGS. 1-4, a bend restrictor 100 is shown in an exemplary embodiment as including first and second segments 110A and 110B, although one skilled in the art will appreciate that a greater number of segments (not shown) can also be assembled together as desired. Further, description of one segment and the components thereof will be applicable to the other segments was particularly noted otherwise.

A segment 110 (e.g., 110A, 110B . . . 110n) includes a housing 120 preferably formed of first and second housing portions 122. Again, in this particular embodiment, the housing portions 122 are identical and thus form housing portion halves. Use of identical halves provides for ease of manufacture, inventory, assembly etc. It will be recognized that in some instances the housing portions 122 may include features described herein without being identical, but rather are substantially identical, to allow the housing portions to be joined together to form a completed housing as part of a segment.

With particular reference to FIGS. 6 and 7, a housing portion 122 includes a first end 124 and a second end 126. A generally semicircular inner surface 128 is formed in the housing portion 122. The inner surface 128 is dimensioned to receive the outer surface of the associated cable C (FIG. 1). The inner surface 128 proceeds over substantially the entire axial length of the housing portion 122.

At the first end 124 of the housing portion there is provided a circumferential, radially extending flange 134 that extends inward into engagement with a circumferential, radially extending recess 136 provided on an outer surface of the adjacent housing portion (or segment). The recess 136 is located at the second end 126 of the housing portion 122 or segment.

Further, protrusions 138 extend from terminal edges of each housing portion 122 where the protrusions are in axially spaced relation, separated by corresponding recesses or gaps 140. Each protrusion 138 includes a passage 142 dimensioned to receive a pin 150 (FIGS. 2-4) that holds the housing portions 122 together over a selected axial portion of the associated cable. Thus, protrusions 138 of one housing portion half 122 are aligned with the gaps 140 in the associated housing portion half, the passages 142 thereby aligned, and the pins 150 axially inserted through the aligned passages 142 in the respective housing portion halves. Thus, the joined housing portion halves 122 form an individual segment (i.e., the segment includes the housing portions and associated pins).

By radially capturing the flange 134 located at the first end 124 of the adjacent, second segment in the gap 136 in the second end 126 of the first segment, limited pivoting movement of the first segment relative to the adjacent, second segment is possible. This is represented in FIGS. 15-16 where limited pivoting or angular movement between adjacent segments is illustrated. The pivoting movement is limited as a result of the flanges 134 engaging the surfaces or shoulders that define the recesses 136 in the adjacent segment.

The bend restrictor 100 also includes a split starting adapter 160 (FIGS. 1-5). Adapter portions 162, again, are preferably identical in construction to define adapter halves that are easily assembled together. Preferably, fasteners interconnect the two halves or adapter portions together to form the adapter 160. The adapter 160 includes a recess 166 between adjacent shoulders that is similar to the recess 136 in each housing portion in order to receive the radially inward extending flange 134 of the first housing portion/segment.

A split locking collar 170 is formed by first and second locking collar portions 172. The locking collar 170 is preferably dimensioned for receipt in the recess 136 of the last segment in the assembly. As illustrated in FIGS. 1-5, the split locking collar portions 172 are also assembled together by use of a fastener or quick lock 174 (FIGS. 1-2) that is oriented ninety degrees relative to the orientation of the pins 150. The split locking collar portions 172 are dimensioned for receipt in the recess 136 of the last housing halves or segment.

FIG. 6 illustrates that the passages 142 are located approximately 180° part. Again, the location of the passages 142 can be altered i.e. they need not be 180° apart, but could be at a different circumferential spacing. Further, the passages 142 in one segment may be oriented or rotated relative to the location of the passages in an adjacent segment. In this manner, the split plane between axially adjacent housing portions/segments may be offset relative to the split plane of the housing portions that form an adjacent segment.

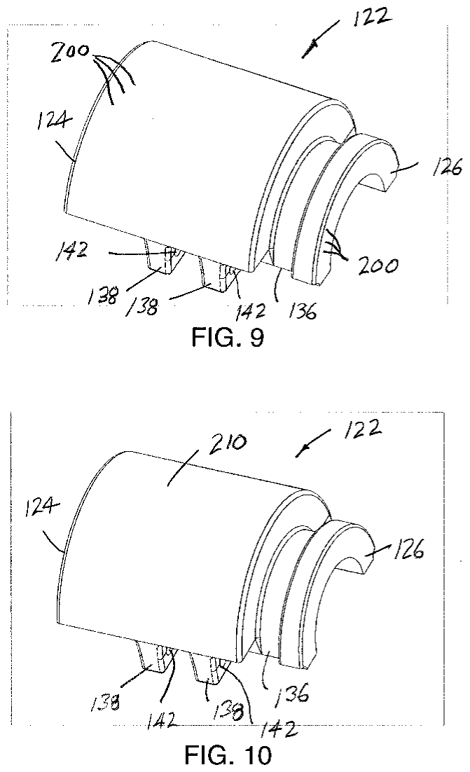

FIGS. 8-10 illustrate various reinforcement members that can be incorporated into the housing portions for strength, or rigidity. Here, individual arc-shaped reinforcement members 190 are axially spaced apart in the embodiment of FIG. 8. In the arrangement of FIG. 9, axially extending reinforcement members 200 are circumferentially spaced apart, and may be provided at radially inner and outer locations as desired and/or required for strength purposes. In FIG. 10, the reinforcement member may be a mesh or woven material 210, for example, that extends over both an axial extent and arc shape of a housing portion. It is particularly contemplated that these reinforcement members may be included into a housing portion made of a moldable material such as urethane, although other moldable materials (plastic, other resins) could likewise include reinforcement members of one or more these types therein.

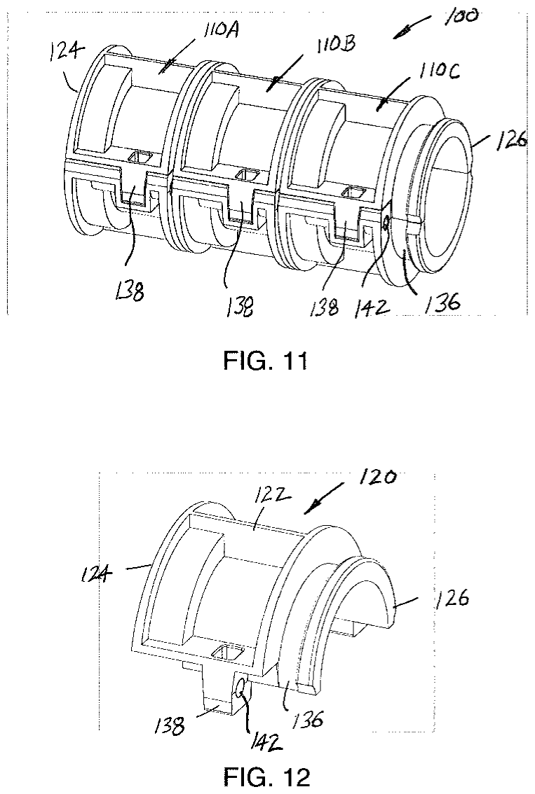

FIGS. 11-13 illustrate a metal version of the bend limiter. It will be appreciated that the same concepts described with the previous figures are suitable for use in the metal version of this design. The metal structure is designated for higher loads and thus may not require additional use of reinforcement members. It is also contemplated that the metal version of the bend limiter can be partially or fully encompassed in a flexible sealing material such as urethane (FIG. 15). Of course other materials (plastic, other resins) can be used with equal success.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A segmented cable protection device that limits the minimum bend radius of an associated cable comprising:
a segment including a (i) housing having first and second housing portions having mating, interlocking protrusions that form the housing of the device, each protrusion has an internal passageway, and (ii) a locking pin dimensioned for receipt through aligned passageways of the protrusions to maintain the housing portions together, the housing dimensioned to receive the associated cable therethrough;
at least first and second segments that are connected to one another for limited pivoting/bending movement relative to one another when disposed in end-to-end connected relation over the associated cable and flexibly interconnected to one another; and
a locking collar that keeps in place the pin of an endmost of the at least first and second segments of the device.

2. The device of claim 1 wherein the first and second housing portions are identical.

3. The device of claim 1 wherein the first and second housing portions form one-half of the segment.

4. The device of claim 1 wherein the housing is formed at least in part of urethane.

5. The device of claim 4 wherein the urethane is in the range of approximately Shore hardness 85A-80D.

6. The device of claim 5 further comprising a strengthening member received in the urethane.

7. The device in claim 4 further comprising a strengthening member received in the urethane.

8. The device in claim 7 wherein the strengthening member includes at least one of reinforcement materials, rods, springs, matting, ropes, formed shapes or stiffening members.

9. The device of claim 4 further comprising a thermally conductive material in the urethane that enhances thermal conductivity and reduces heat buildup from the associated cable.

10. The device in claim 1 wherein the housing portions are dimensioned to form a through opening that ranges from 30-300 mm in diameter.

11. The device in claim 1 further comprising a urethane molding received over the assembled first and second housing portions.

12. The device in claim 1 where the locking pins of adjacent segments are located at different circumferential positions in different segments.

13. The device in claim 1 wherein the housing portions are formed of a material or combination of materials that have a buoyancy in water.

14. A method of making a segmented cable protection device that limits the minimum bend radius of an associated cable comprising:
supplying first and second housing portions mating to form a segment of the device and dimensioned to receive the associated cable therethrough when the housing portions are assembled together;
including interlocking protrusions on the housing portions;
providing an internal passageway in the protrusions for receiving a locking pin; and
assembling a locking collar on the housing portions that keeps the pin of the segment in place.
